(19) United States
(12) Patent Application Publication
(10) Pub. No.: US 2019/0130480 A1
(43) Pub. Date: May 2, 2019

(54) Method for improved product acquisition using dynamic residual values

(71) Applicants: Chad R. BREWBAKER, Clive, IA (US); Robert L. BIERMAN, Polk City, IA (US)

(72) Inventors: Chad R. BREWBAKER, Clive, IA (US); Robert L. BIERMAN, Polk City, IA (US)

(21) Appl. No.: 15/799,603

(22) Filed: Oct. 31, 2017

(51) Int. Cl. G06Q 40/02; G06Q 30/02

(52) U.S. Cl. CPC G06Q 40/025; G06Q 30/0206

(57) ABSTRACT

A method for pre-qualifying, pre-approving or comparing product acquisition offers from previously input lender offers using dynamic residual value calculations may include an input device with a user interface for requesting buyer and product information and type of lending desired. This method may include dynamically generated residual valuations of products using market transactions, such as weighted historical and current market product valuations. The method may use the dynamically generated residual value to display on the input device a ranked list of offers from lenders. The method may include the buyer selecting and executing one of the offers and acquiring the product and optional ancillaries.

### TECHNICAL FIELD

The disclosed embodiments relate generally to a method for acquiring products and, more particularly to a method that streamlines the acquisition of products, using dynamic residual value calculations to equalize competing lending offers from an aggregate of product specific lenders.

### BACKGROUND

It is frequently desirable to purchase products, such as vehicles, online. The purchase or lease of more expensive items often requires the party acquiring the product to engage a lender to underwrite the cost of financing, whether that financing is in furtherance of a loan or a lease. Searching for a lender with desirable financing can take a considerable amount of time and effort. Sometimes the search for financing takes too long and the desired product is no longer for sale or lease.

Another drawback associated with prior art financing systems is that the acquirer may have to apply to multiple lenders, providing each with personal financial information that the lenders use to determine the suitability of the acquirer to receive financing. Lenders may use the acquirer's personal financial information to pull credit reports to determine the acquirer's credit score. These multiple credit pulls may decrease the acquirer's credit score.

Yet another drawback associated with prior art is that often the seller or lessor is involved with helping the acquirer select a lender, sometimes even offering the financing themselves. The seller or lessor may receive compensation for financing the loan themselves or may receive compensation from a third-party lender for bringing the acquirer to the lender. These factors may lead to the acquirer obtaining loan terms that are optimal for the seller or lessor, but which may be suboptimal for the acquirer.

When determining the terms of a loan for a product, lenders often need to determine the residual value of the product. If the lender knows the product will have a large residual value at the end of the sale or lease, the lender may be able to provide the acquirer a larger loan amount on more favorable terms. A drawback associated with the prior art is that residual value calculations used by lenders may be dated and may not rely on accurate methodology. The difference between the current residual value of the product and the residual value used by the lender may lead to suboptimal loan terms for the lender or the acquirer.

### SUMMARY OF THE DISCLOSED SUBJECT MATTER

The deficiencies described above are overcome by the disclosed implementation of a method to consolidate product financing using dynamic residual value calculations. A user inputs information regarding the buyer and a desired product into an input device using a user interface such as a graphical user interface. The method dynamically generates a residual value of the product using weighted historical and real time product valuations. The method uses the dynamically generated residual value to standardize various financing offers for ranking purposes. The financing offers are ranked and displayed on a user interface. The buyer selects one or more of the resulting financing offers from previously input lender offers for one or more of the selected products for comparison or execution purposes.

Other implementations of the method for comparing or approving product financing using dynamic residual calculations are disclosed, including implementations directed to approving vehicle lease financing or optimizing dealer profits using dynamic residual value calculations.

### BRIEF DESCRIPTION OF THE DRAWINGS

The present invention will now be described, by way of example, with reference to the accompanying drawings in which:

FIG. 1 illustrates a block diagram of the system architecture in accordance with one embodiment;

FIG. 2 illustrates a block diagram of the cloud infrastructure in accordance with one embodiment;

FIG. 3 illustrates a flow diagram of the method of making a financing offer in accordance with one embodiment;

FIG. 4 illustrates a flow diagram of webpages presented to a user in accordance with one embodiment;

FIG. 5 illustrates a flow diagram of the method of pre-qualifying a user in accordance with one embodiment; and

FIG. 6 illustrates a flow diagram of webpages for pre-qualifying a user in accordance with one embodiment.

### DETAILED DESCRIPTION OF THE DRAWINGS

The system of the present invention facilitates an acquirer obtaining pre-qualification and engaging with a lender for financing of a product using a dynamic residual value calculation to approve the financing. The system described below is distinguished over earlier systems such as that described in U.S. Pat. No. 9,576,321 in that the system of the present invention does not require sufficient personal information from an acquirer to make a credit inquiry that may damage the acquirer's credit score. The present system uses current residual values of the product to allow a lender to more accurately calculate loan terms.

One embodiment of the present system involving a lease uses an internal payment calculator to use the type of lease desired by the acquirer and subtract the acquirer's down payment from the price of a product. The system uses details about the product and the type of lease desired by the acquirer and a residual value predictor to generate an estimated residual value of the product using market transactions. The market transactions may be of any type known in the art, but are preferably weighted historical wholesale and retail pricing over multiple years for multiple types of products. The internal payment calculator subtracts the estimated residual value from the price of the product and amortizes the remaining balance and any additional costs using interest rates provided by multiple lenders. The system provides information to the acquirer regarding calculated weekly and monthly payment amounts for multiple lenders, ranking the lenders by desirability based on the acquirer's preference. The acquirer may then select a lease option from the information provided.

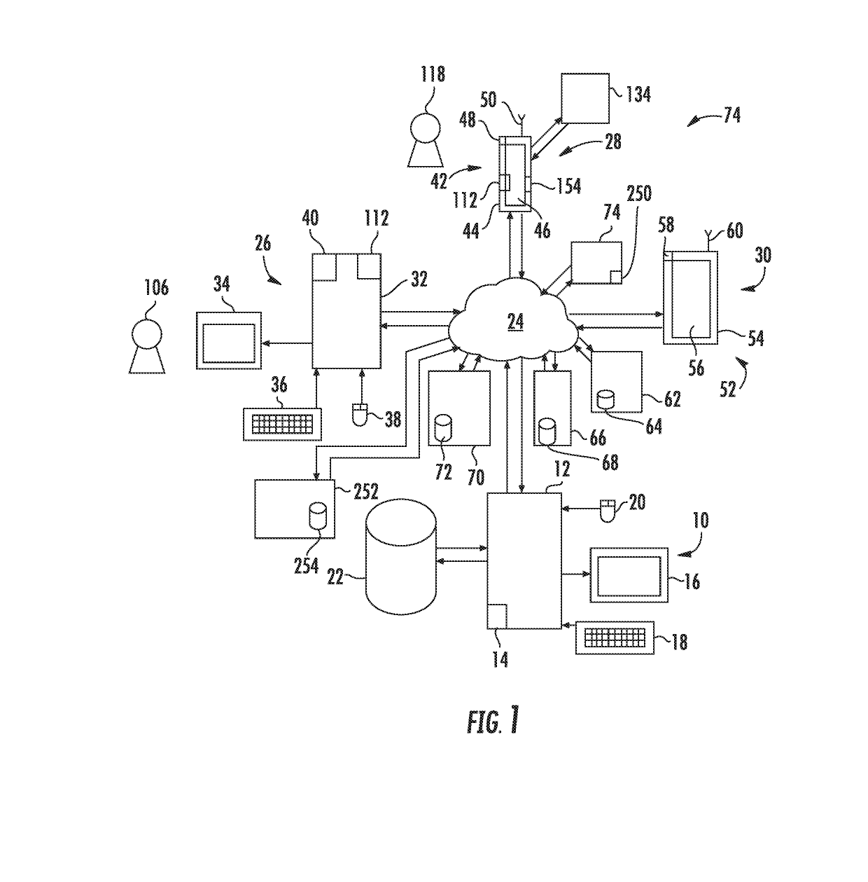

FIG. 1 is a component diagram of components included in a typical implementation of the system and method of the present invention in the context of a typical operating environment. As illustrated, the operating environment includes a non-transitory computer-readable medium storing instructions that, when executed by one or more processors in a computing device, cause that computing device to perform functions detailed more fully below. In the preferred embodiment, this medium is computer storage associated with one or more servers running a cloud infrastructure system (74) described more fully below. A data processing system (10) includes a computer acting as a server (12), and has memory (14) containing computer executable instructions for processing information. The server (12) is preferably provided with a display (16) and input devices, such as a keyboard (18) and mouse (20). The server (12) is coupled to a database (22) and a network (24). The server (12) is part of a client server model in a distributed application structure, communicating with various clients (26 28 and 30) over the network (24). The network (24) may be of any type known in the art, including, but not limited to, the Internet, a local area network (LAN), a wide-area network (WAN), telephony, or any combination thereof. In the preferred embodiment, the network (24) is a global communications network such as the Internet.

The clients (26 28 and 30) may be any type of client known in the art including, but not limited to a desktop, workstation, notebook, net book, net tablet, mainframe, terminal, or any device having the capability of communicating over a network. Preferably, client (26) is a computer (32) coupled to a display (34), a keyboard (36), and a mouse (38). The computer (32) is provided with memory (40) such as that known in the art, containing computer executable instructions for processing information.

Client (28) is a mobile device (42) having a computer (44), a touch screen (46), and memory (48) containing computer executable instructions for processing information. The mobile device (42) may be a mobile phone or any device known in the art. The mobile device (42) is provided with an antenna (50), such as those known in the art to wirelessly communicate with the network (24). The client (30) is a tablet device (52) having a computer (54) a touch screen (56) and memory (58) containing computer executable instructions for processing information. The tablet device (52) is also provided with an antenna (60) to wirelessly connect to the network (24). Also connected to the network (24) are a wholesale price server (62) having an associated database (64), a retail price server (66) having an associated database (68), and a credit bureau server, such as a consumer reporting agency server (70) having an associated database (72).

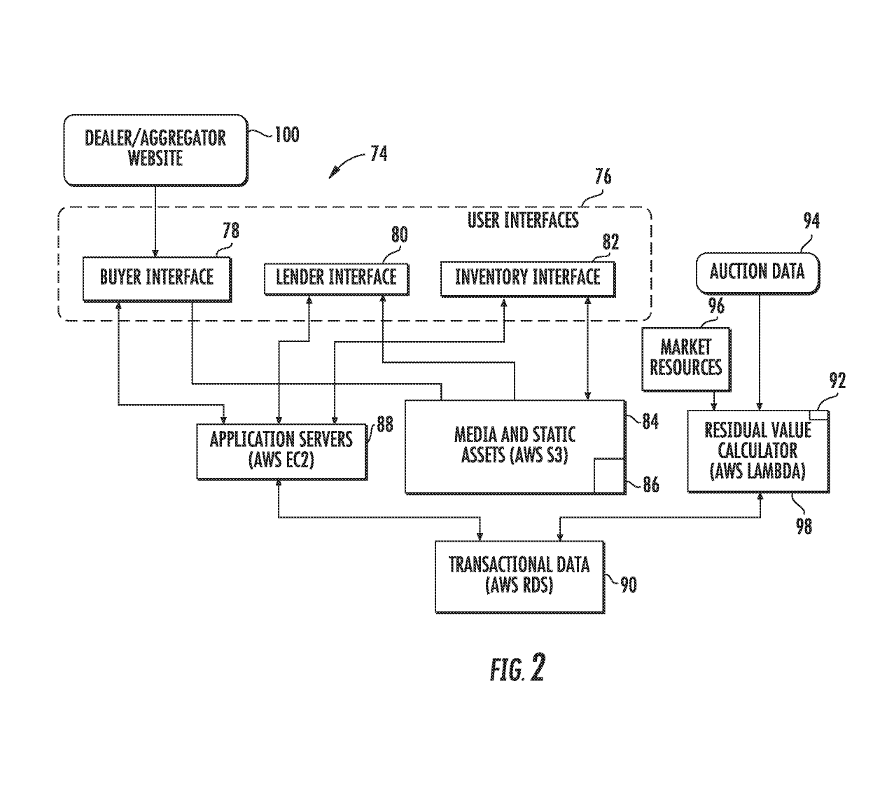

A cloud infrastructure system (74) is provided having non-transitory computer-readable medium storing instructions and associated with one or more servers, preferably Amazon Web Services, and is connected to the network (24). FIGS. 1-2. If desired, the cloud infrastructure system (74) may be provided with a firewall in any manner known in the art. As shown in FIG. 2, the cloud infrastructure system (74) is provided with user interfaces (76). Preferably, the user interfaces (76) include a user or buyer interface (78), a lender interface (80), and an inventory interface (82). Additional interfaces, such as those known in the art, may be provided in addition to, or in place of, the interfaces (78), (80), and (82). The user interfaces (76) are associated with data (84), such as media and static assets stored on a flexible storage service (86), such as Amazon Web Services Simple Storage Service (AWS S3) for hosting of files and staging for large data uploads. The user interfaces (76) are also associated with one or more servers (88), preferably elastic web-scale computing servers, such as Amazon Web Services Elastic Compute Cloud (AWS EC2), to allow for fluctuations in server demand and to facilitate computer operations that benefit from persistent in-memory cache. The servers (88) communicate with a database (90), preferably a scalable transactional database, such as Amazon Web Services Relational Database Services (AWS RDS). In turn, the database communicates with a residual value calculator application (92). The residual value calculator application (92) is executable software code that applies one or more algorithms to input data, such as current and historical product auction data (94), such as sale prices on eBay, and market value resources (96), such as Kelley Blue Book, to return a residual value for a given product at a given point in time, preferably a future point in time associated with the termination date of a lease or a loan. The residual value calculator application (92) operates as a forecasting model for lenders (106), assisting lenders (106) in evaluating future valuation considerations associated with products by identifying anticipated future increases and decreases in product values. A computing platform (98) is provided to run the residual value calculator application (92). The computing platform (98) is preferably a scalable, event-driven, platform capable of dynamically managing the allocation of machine resources on demand, such as Amazon Web Services Lambda (AWS Lambda), capable of administering the software code for the cloud infrastructure system (74). The user interfaces (76) access information pertaining to available products from a dealer or aggregator website (100).

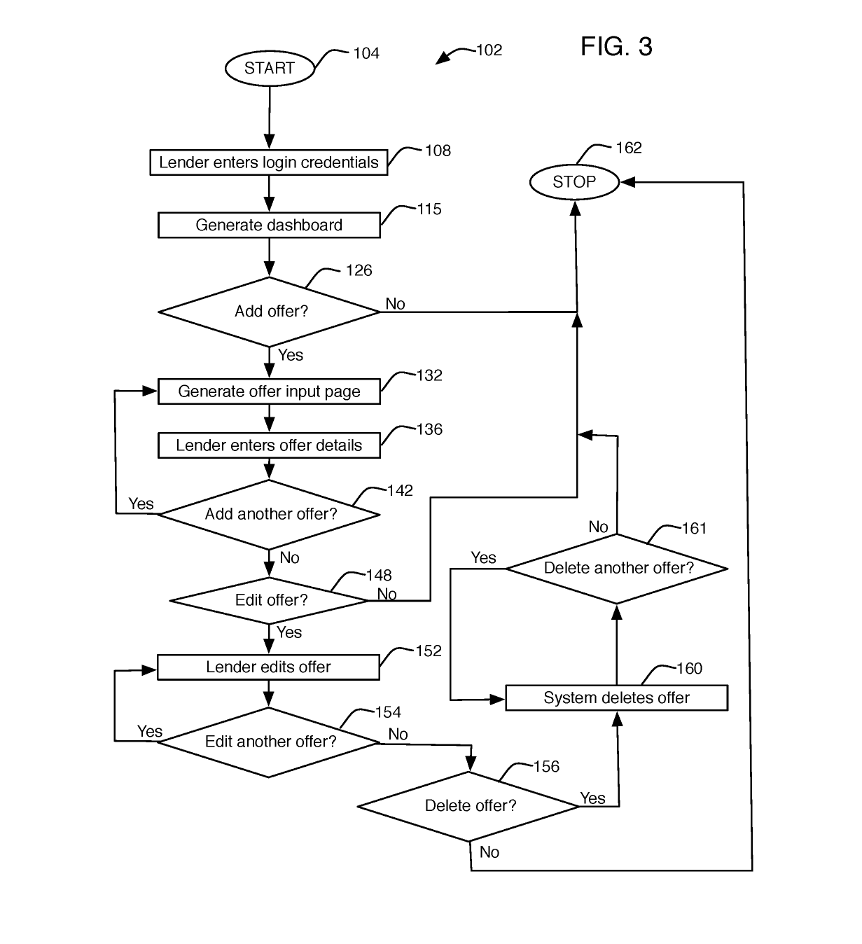

FIG. 3 is a flow diagram showing the method (102) typically performed by the system (10) for entering lender data into the cloud infrastructure system (74) The method (102) starts (104) with a lender (106) using a lender input device, such as a client (26), to enter (108) the username and password (110) into the database (90) of the system (10). The cloud infrastructure system (74) uses a browser (112) associated with the client (26) to present the lender (106) with the physically perceptible lender interface (80) that displays, one or more webpages, such as those static webpages described below. (FIGS. 1-2 and 5-6) Alternatively, the lender interface (80) can be an audio or haptic interface such as those known in the art. (FIGS. 1-4).

The lender (106) enters (108) the username and password (110) into a login webpage (114) generated by the cloud infrastructure system (74). The system (10) preferably builds the lender interfaces (80), such as the login webpage (114), with Single Page Applications (SPA) using a progressive JavaScript (JS) framework for building use interfaces such as Vue.js, polyfills, such as Fetch and/or a Promise implementation of Lodash, a state management pattern and library such as Vuex, a router, such as Vue-router, and a Browserify transform for Vue.js components, such as Vueify. However, any similar known progressive framework may be used. While the system (10) preferably uses Asynchronous JavaScript And XML (AJAX) application programming interface (API) fetch requests to communicate remotely entered data entered with the cloud infrastructure system (74), any known communication architecture may be used. The system (10) also uses Browserify to allow the use of Node.js modules that compile for use in the browser (112). The lender interface (80), including the login webpage (114), preferably has a JS Object object to store and validate all data inputs.

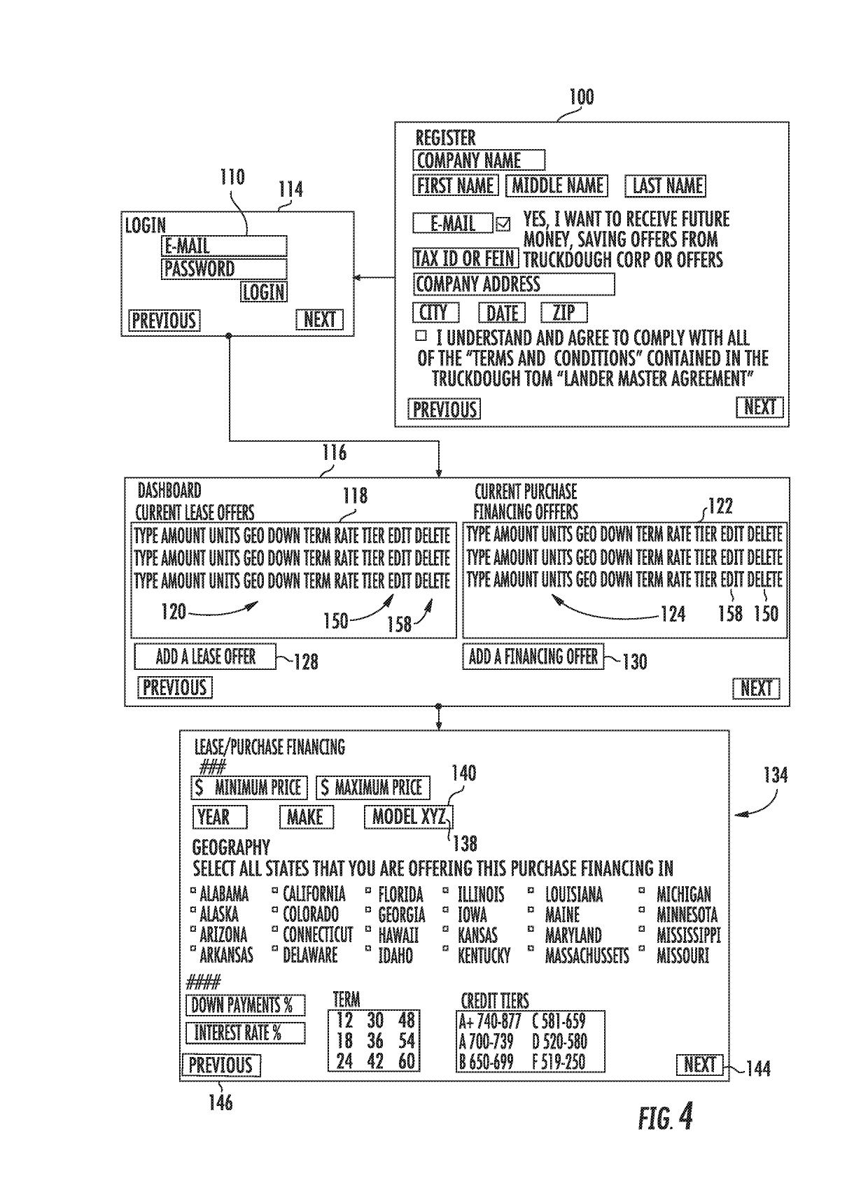

Once the lender (106) enters (108) the username and password (110) into the login webpage (114), the cloud infrastructure system (74) generates (115) a dashboard webpage (116) associated with the lender (106). As shown in FIG. 4, the dashboard webpage (116) displays a first table (118) showing the lender's (106) current lease offers (120) entered into the cloud infrastructure system (74) and a second table (122) showing the lender's (106) current purchase financing offers (124) entered into the cloud infrastructure system (74).

If the lender (106) desires to add (126) an additional offer to the system, the lender (106) selects the “Add a Lease Offer” button (128) or “Add a Purchase Financing Offer” button (130) on the dashboard webpage (116), causing the cloud infrastructure system (74) to generate (132) an offer input webpage (134) associated with the lender (106). From the offer input webpage (134), the lender (106) enters (136) data (138) relating to the new lease offer or new purchase financing offer into the various fields (140) located on the offer input webpage (134). As shown in FIG. 4, the fields (140) may request data (138) relating to price, make, model, and year of the product, geographical location, down payment, term, and credit tiers. More, fewer, or different fields (140) may be presented on the offer input webpage (134), if desired. Once the data (138) has been entered into the fields (140) on the offer input webpage (134), if the lender (106) desires to add (142) an additional offer to the cloud infrastructure system (74), the lender (106) selects the “Next” button (144) on the offer input webpage (134), causing the cloud infrastructure system (74) to send the data (138) across the network (24) to the database (90) and generate (132) another offer input webpage (134) associated with the lender (106). The lender (106) enters data related to the additional offer into the input webpage (134) and the process continues until the lender (106) does not wish to add any more additional offers into the cloud infrastructure system (74). Once the lender (106) does not wish to add any more additional offers into the system (10), the lender (106) selects the “Previous” button (146) causing the cloud infrastructure system (74) to send the data (138) across the network (24) to the database (90) and generate (115) the dashboard webpage (116).

If the lender (106) desires to edit (148) an existing offer, the lender (106) selects the “Edit” button (150) associated with the appropriate offer on the dashboard webpage (116), causing the cloud infrastructure system (74) to generate (132) the offer input webpage (134) prepropogated with the data (138) associated with the offer. The lender (106) then edits (152) the appropriate fields (140) and selects the “Previous” button (146), causing the cloud infrastructure system (74) to send the data (138) across the network (24) to the database (90) and generate (115) the dashboard webpage (116). The lender (106) may then edit (154) another existing offer using the same process. If the lender (106) desires to delete (156) an existing offer, the lender (106) selects the “Delete” button (158) associated with the appropriate offer on the dashboard webpage (116), causing the cloud infrastructure system (74) to delete (160) the offer from the database (90) and generate the dashboard webpage (116) with the offer deleted. If the lender (106) desires to delete (161) another existing offer, the lender (106) repeats the process. Once the lender (106) is finished editing offers on the dashboard webpage (116), the lender (106) may simply close the dashboard webpage (116) and the method ends (162).

The system (10) allows a lender (106) to modify offers in real-time. The system (10) maintains offer logs of offers created by the lender (106). When a lender (106) adds or modifies data the system (10) issues a POST request (similar to a JS push request) to update the database (90) and make the changes immediately available. Similarly, when a lender (106) deletes data the system (10) also issues a POST request to update the database (90) and make those changes immediately available as well. The system (10) uses AWS CodeBuild to set up node packet manager (npm) packages and cache them as build artifacts.

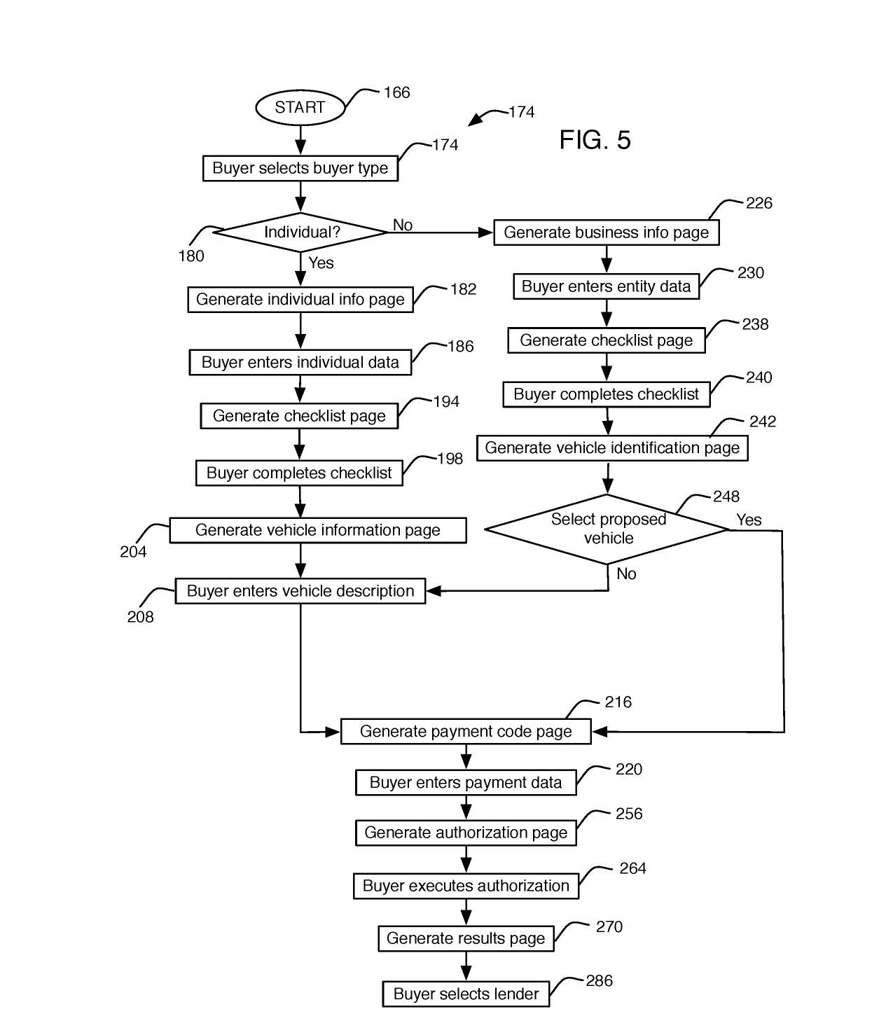

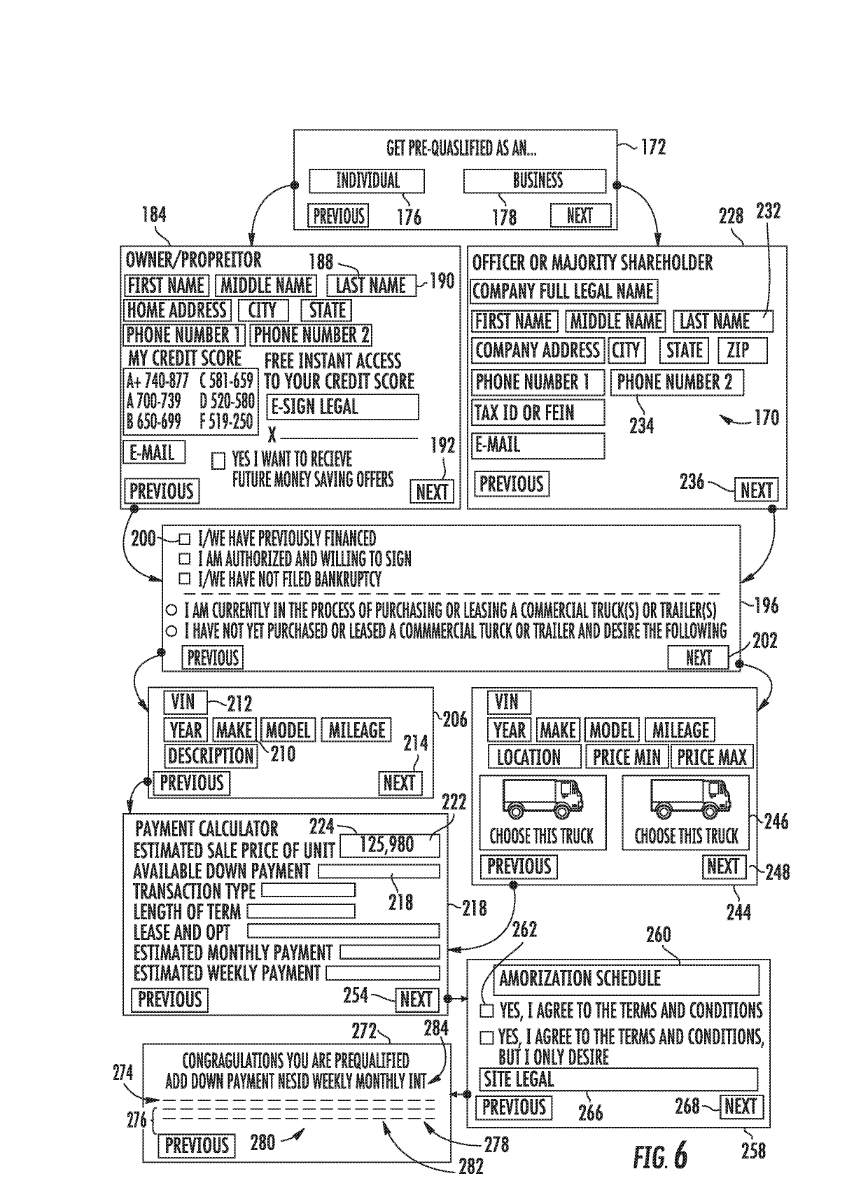

FIG. 5 is a flow diagram showing the method (164) typically performed by the system (10) for pre-qualifying a user, such as a buyer (118), who is preferably a prospective product acquiror, and more preferably a vehicle buyer. It should be noted, however, that the system (10) may be used to pre-qualify a buyer (118) before acquiring any product, such as equity positions, which may include commodities, stocks, bonds, and/or derivatives, and the like, wherein the acquisition may be outright, through a margin account, or by any other means known in the art. The method (164) starts (166) with the buyer (118) using a buyer input device, such as client (28) or (30) to enter (168) data (170) into the database (90) of the system (10). The cloud infrastructure system (74) uses a browser (112) associated with the client (28) or (30) to present the buyer (118) with the physically perceptible buyer interface (78), such as one or more static webpages, such as those described below. (FIGS. 1-2 and 5-6) Alternatively, the physically perceptible buyer interface (78), can be an audio or haptic interface such as those known in the art. As shown in FIGS. 5-6, the cloud infrastructure system (74) generates (115) a static webpage, such as an introductory webpage (172). The buyer (118) selects (174) the “Individual” button (176) or “Business” button (178) on the introductory webpage (172). The selection is sent through the network (24) to the cloud infrastructure system (74). The cloud infrastructure system (74) determines (180) if the buyer (118) is an individual or a business. If the buyer (118) is an individual, the cloud infrastructure system (74) generates (182) an owner data page (184). The buyer (118) enters (186) the required data (188) into the fields (190) on the owner data page (184). The required data (188) may be any type of data known in the art, but preferably includes the buyer's name, address, contact information and estimated credit score. As shown in FIGS. 1 and 5-6, once the required data (188) has been entered and the buyer (118) selects the “Next” button (192) the cloud infrastructure system (74) sends the required data (188) to the database (68) and the computing platform (98). The cloud infrastructure system (74) may also send the required data (188) to the buyer identification and management system (82) to set up login credentials for the buyer (118) in the event the buyer (118) wishes to log into the system (10) and retrieve previously entered data in the future.

Once the buyer (118) enters (186) the required data (188) into the fields (190) on the owner data page (184), the cloud infrastructure system (74) generates (194) a checklist webpage (196) requesting the buyer (118) to check (198) various boxes (200) to confirm certain items, such as the buyer's authorization to execute financing documents. Once the buyer (118) selects the “Next” button (202) the cloud infrastructure system (74) sends the check box confirmations (198) to the database (90) and the computing platform (98) and generates (204) a vehicle identification webpage (206), through which the system (10) requests information about the product, such as the vehicle identification number (VIN) of a desired vehicle. The buyer (118) enters (208) the requested data (210) into the fields (212) on the vehicle identification webpage (206). The requested data (210) may be any type of data known in the art, but preferably includes the VIN, the make, model, year, and mileage of the vehicle. Alternatively, the vehicle identification webpage (206) may be a page requesting data relating to any product the buyer (118) may wish to buy or lease. Preferably the vehicle identification webpage (206) requests information relating to vehicles or machinery in the fields of transportation, construction, agriculture, or aircraft.

As shown in FIGS. 1 and 5-6, once the requested data (210) has been entered and the buyer (118) selects the “Next” button (214) the cloud infrastructure system (74) sends the requested data (210) to the database (90) and the computing platform (98) and generates (216) a payment calculator webpage (218) requesting the buyer (118) to enter (220) data (222) into the fields (224) relating variously to the list price of the vehicle, the buyer's desired available down payment, whether the buyer (118) desires a lease or purchase financing, the estimated monthly payment and estimated weekly payments.

As shown in FIGS. 5-6, if the buyer (118) selects (174) the “Business” button (178) on the introductory webpage (172) the cloud infrastructure system (74) generates (226) a business data page (228). The buyer (118) enters (230) the required data (232) into the fields (234) on the business data page (228). The required data (232) preferably includes the company name, federal employer identification number (FEIN) or tax identification number (TIN), company name, address, and contact information. As shown in FIGS. 1 and 5-6, once the required data (232) has been entered and the buyer (118) selects the “Next” button (236) the cloud infrastructure system (74) sends the required data (232) to the database (90) and the computing platform (98). The cloud infrastructure system (74) may also set up login credentials for the buyer (118) in the event the buyer (118) wishes to log into the system (10) and retrieve previously entered data in the future.

Once the buyer (118) enters (230) the required data (232) into the fields (234) on the business data page (228), the cloud infrastructure system (74) generates (238) the checklist webpage (196) which requests the buyer (118) to check (240) the various boxes (200) to confirm certain items, such as the buyer's authorization to execute financing documents as described above. Once the buyer (118) selects the “Next” button (202) the cloud infrastructure system (74) sends the check box confirmations (240) to the database (90) and the computing platform (98) and generates (242) a vehicle identification webpage (244). The a vehicle identification webpage (244) may be similar to the vehicle identification webpage (206) for individuals, or may, as shown in FIG. 6, include different or additional information, such as proposed vehicle offerings (246) based on the buyer (118), the buyer's past purchases, purchases by similar entities, seller incentives, or any other desired criteria. If the buyer (118) selects (248) one of the proposed vehicle offerings (246), the cloud infrastructure system (74) sends data associated with the proposed vehicle offerings (246) to the database (90) and the computing platform (98) and generates (216) the payment calculator webpage (218) requesting the buyer (118) to enter data (222) into the fields (224) relating to the vehicle as described above. If the buyer (118) has selected one of the proposed vehicle offerings (246), the cloud infrastructure system (74) may propagate one or more fields of the payment calculator webpage (218) with data associated with the proposed vehicle offering (246). If the buyer (118) does not select one of the proposed vehicle offerings (246), when the buyer (118) selects the “Next” button (248), the cloud infrastructure system (74) simply generates (216) the payment calculator webpage (218) in a manner described above for the buyer (118) to enter (208) data (222) into the fields (224) relating variously to the list price of the vehicle, the buyer's desired available down payment, whether the buyer (118) desires a lease or purchase financing, the estimated monthly payment and estimated weekly payments.

The payment calculator webpage (218) is designed in a manner such as that known in the art so that the cloud infrastructure system (74) autocompletes the remaining fields based on the data entered by the buyer (118). For instance, if the buyer (118) enters data into the respective fields (224) relating to the sale price of the vehicle, the available down payment, the transaction type being a lease, the length of the term, and a lease end option, as this data is entered, the cloud infrastructure system (74) autocompletes the remaining fields relating to estimated monthly payment and estimated weekly payment.

To autocomplete the remaining fields on the payment calculator webpage (218), the cloud infrastructure system (74) uses a dynamic prediction model to calculate an estimated residual value for the vehicle the buyer (118) wishes to purchase or lease. The dynamic prediction model uses weighted historical and current, preferably real time, vehicle valuations to calculate an estimated future residual value for the vehicle to use on the payment calculator webpage (218).

The cloud infrastructure system (74) connects to the wholesale price server (62) and retail price server (66) across the network (24) to access the associated databases (64) and (68) respectively to obtain current, preferably real-time, and historical wholesale and retail values for vehicles having the same or similar make, model, year, and mileage of the desired vehicle. The cloud infrastructure system (74) also uses a vehicle auction API (250) to query one or more vehicle auction servers (252). The vehicle auction servers (252) are associated with databases (254) containing current auction results for auctioned vehicles. The vehicle auction servers (252) and associated databases (254) may be public vehicle auction servers and databases run by third parties, or may be private vehicle auction servers and databases run by third parties or proprietary to the system (10). The cloud infrastructure system (74) can use the vehicle auction API (250), vehicle auction servers (252), and databases (254) to search completed auctions for the exact make, model, and year of the desired vehicle having similar mileage. In addition, the cloud infrastructure system (74) can search for completed auctions for similar vehicles, weighting the results using any desired algorithm to determine current residual vehicle value data. The cloud infrastructure system (74) dynamically combines current and historical residual vehicle values data stored in the database (90), weighted as desired, with the current and historical residual vehicle valuations described above using any desired predetermined or dynamic algorithms to calculate an estimated residual value for the vehicle the buyer (118) wishes to purchase or lease. The cloud infrastructure system (74) then uses this estimated residual value for the vehicle the buyer (118) wishes to purchase or lease to autocomplete the remaining fields on the payment calculator webpage (218).

The cloud infrastructure system (74) uses either the buyer's own estimated credit score submitted to the system (10) or a “soft pull” of the buyer's credit score to estimate the appropriate interest rate for the buyer (118), rounding the interest rates to the nearest decimal to aid in comparing competing loan offers. Once the buyer (118) has entered the data (222) into the fields (224) of the payment calculator webpage (218) to the buyer's satisfaction, the buyer (118) selects the “Next” button (254) and the cloud infrastructure system (74) generates (256) an authorization webpage (258) providing an amortization schedule (260) based on the data from the payment calculator webpage (218). The authorization webpage (258) also has authorization checkboxes (262) indicating the buyer's agreement (264) with the terms of the amortization schedule (260) and legal information (266) relating to the loan process. Once the buyer (118) has completed the authorization webpage (258) and selected the “Next” button (268), the cloud infrastructure system (74) generates (270) the results webpage (272).

As shown in FIG. 6, the results webpage (272) sends a physically perceptible form of information relating to a target financing option (274) and a supplemental target financing options (276) to the client (28) or (30) associated with the buyer (118) by generating the information on the screen (46) or (56). The target financing option (274) is preferably a pre-approved financing offer, such as a purchase financing or lease offer. The target financing option (274) is preferably the optimal financing option, as determined by the cloud infrastructure system (74) by dynamically using the estimated residual value for the vehicle the buyer (118) wishes to purchase or lease calculated above to compare financing options submitted to the system (10) as lease offers (120) and purchase financing offers (124) by various lenders (106). While any lenders (106) may be used, the various lenders (106) are preferably selected from a pre-determined list of vendors (106) which may be chosen using any desired criteria, such as size, portfolio, experience, past transactions, customer ratings, fees paid, or any other criteria known in the art. Everything else being equal, the optimal financing option is typically the financing option resulting in the lowest periodic payments for the buyer (118). The supplemental target financing options (276) are preferably the financing options resulting in the next lowest periodic payments for the buyer (118).

If desired, the target financing option (274) and supplemental target financing options (276) may include a combination of lenders (106). For instance, the loan, may be a lease that has a collateralized portion associated with a first interest rate and uncollateralized portion associated with a second interest rate, different than the first interest rate. To accomplish this, the lease may be divided into two types of loan: the loan associated with the residual value of the product (which would be the collateralized portion of the loan); and the loan associated with the depreciation associated with the product over the life of the loan (which would be the uncollateralized portion of the loan). By dividing the loan into collateralized and uncollateralized components, if one lender (106) offers a lower rate for the collateralized residual value portion of the loan, and another lender (106) offers a lower rate for the uncollateralized depreciation portion of the loan, the target financing option (274) and supplemental target financing options (276) may be hybrid offers that include a combination of lenders (106) and interest rates for the collateralized residual value portion of the loan and the uncollateralized depreciation portion of the loan.

As shown in FIG. 6, the cloud infrastructure system (74) presents the information relating to target financing option in the form of a list (278) of financing offers (280) from various lenders, listing in ascending order of the amount of periodic payments to be paid by the buyer (118), or based on any other desired predetermined algorithm. The predetermined algorithm may be varied as desired to give more or less weight to various loan attributes, such as location, but generally lists the loan offers in ascending order of the size of the weekly or monthly payments required of the buyer (118) for the given loan term. The results webpage (272) also lists additional details (282) of the financing offers (280), such as loan amount, interest rate, location of financing entity, etc. Preferably, the buyer (118) may select any of the headings (284) associated with the additional details (282) to reorder the list (278) of financing offers (280) by the selected headings (284).

The buyer (118) may select (286) a financing offer (280), preferably the target financing option (274), from the list (278), which causes the cloud infrastructure system (74) to send data associated with the selected financing offer (280) to the associated lender (106). Alternatively, in response to the buyer (118) selecting a financing offer (280), the cloud infrastructure system (74) may display on the screen (46) or (56) supplemental information associated with the selected financing offer (280), such as the associated lender's contact information, allowing the buyer (118) to contact the lender (106).

Once the lender (106) is aware of the buyer's prequalification, either from the cloud infrastructure system (74) or directly from the buyer (118), the lender (106) conducts due diligence associated with the buyer (118) and with the selected financing offer (280) and may contact the buyer (118) directly or through the system (10) for additional information. Alternatively, if the lender (106) determines the buyer's credit rating is not accurate, the lender (106) may deny the selected financing offer (280) or send the buyer (118) details associated with a new financing offer reflecting the buyer's actual credit rating. Once the lender (106) has successfully conducted its due diligence, the lender (106) forwards a formal financing instrument, such as a loan or lease agreement, to the buyer (118) for execution. Once the buyer (118) executes the formal financing offer and returns it to the lender (106), the lender (106) submits the appropriate funds to the current owner of the vehicle and the current owner transfers title to the vehicle to the lender (106) and physical possession of the vehicle to the buyer (118).

In the preferred embodiment, upon execution of a formal financing offer between the buyer (118) and the lender (106), the lender (106) provides a fee to the party managing the system (10). This fee can be a flat fee per transaction, a flat fee for unlimited transactions within a given time period or, preferably, a percentage of the financing amount, such as one percent of the amount of the funds transferred from the lender (106) to the current owner of the vehicle.

The cloud infrastructure system (74) is designed to periodically compare lease offers (120) and purchase financing offers (124) submitted by lenders (106) to determine outliers. In the event the cloud infrastructure system (74) determines a lease offer (120) or purchase financing offer (124) submitted by a lender (106) falls outside predetermined parameters, constituting an undesirable offer and making it unlikely that such lease offer (120) or purchase financing offer (124) would be submitted to a buyer (118) as outlined above, the cloud infrastructure system (74) will send the associated lender (106) an alert, preferably by email, text, or phone alerting the lender (106) that the lease offer (120) or purchase financing offer (124) falls outside the predetermined parameters.

Although the invention has been described with respect to a preferred embodiment thereof, it is to be understood that it is not to be so limited since changes and modifications can be made therein which are within the full, intended scope of this invention as defined by the appended claims. For example, while the foregoing description relates to a vehicle purchase, the system (10) can be used to facilitate the financing pre-approval and purchase of any desired product.

What is claimed is:

1. A non-transitory computer-readable medium storing instructions that, when executed by one or more processors in a computing device, cause that computing device to perform functions, the functions comprising:
presenting one or more physically perceptible user interfaces in association with an acquirer input device, wherein the one or more user interfaces request product information about a product;
in response to an input of the product information into the one or more user interfaces through the acquirer input device:
dynamically using weighted market transactions valuations to calculate a residual value of the product;
dynamically using the residual value of the product to determine a target financing option;
sending information associated with the target financing option to the acquirer input device; and
presenting the information associated with the target financing option in a physically perceptible manner associated with the acquirer input device.

2. The non-transitory computer-readable medium of claim 1, further comprising, in response to an input of a selection of the information associated with the target financing option, dynamically displaying supplemental information associated with the target financing option in a physically perceptible manner associated with the acquirer input device.

3. The non-transitory computer-readable medium of claim 1, further comprising, in response to an input of a selection of the information associated with the target financing option, sending information associated with the acquirer to a lender associated with the target financing option.

4. The non-transitory computer-readable medium of claim 1, further comprising, in response to an input of a selection of the target financing option, executing a financial instrument between the acquirer and an entity offering the target financing option and providing the product to the acquirer.

5. The non-transitory computer-readable medium of claim 1, further comprising, in response to an input of the product information:
dynamically using the residual value of the product to determine a supplemental target financing option;
sending supplemental information associated with the supplemental target financing option to the acquirer input device; and
displaying the supplemental information associated with the supplemental target financing option in a physically perceptible manner associated with the acquirer input device.

6. The non-transitory computer-readable medium of claim 5, further comprising, in response to an input of a selection of a selected financing option selected from the target financial option and the supplemental target financing option:
executing a financial instrument between the acquirer and an entity offering the selected financing option; and
providing the product to the acquirer.

7. The non-transitory computer-readable medium of claim 1, wherein the target financing option is a pre-approved financing offer.

8. The non-transitory computer-readable medium of claim 1, wherein the target financing option is a lease, wherein the lease comprises a collateralized portion associated with a first interest rate and uncollateralized portion associated with a second interest rate, different than the first interest rate.

9. The non-transitory computer-readable medium of claim 1, wherein the product is a vehicle.

10. The non-transitory computer-readable medium of claim 1, wherein the target financing option is a financing option pre-approved based on the product information and an estimate of the acquirer's credit rating.

11. The non-transitory computer-readable medium of claim 1, wherein the market transactions comprise historical and real time product valuations comprising:
retail pricing from multiple years; and
wholesale pricing from multiple years.

12. A method for facilitating financing of a product by an acquirer using a user interface, the method comprising;
displaying one or more user interfaces on a display associated with an acquirer input device, wherein the one or more user interfaces request product information;
in response to an input of the product information into the one or more user interfaces through the acquirer input device:
dynamically using market transactions to calculate a residual value of the product;
dynamically using the residual value of the product to determine a plurality of financing options;
ranking the plurality of financing options in order of desirability;
sending information associated with the plurality of financing options to the acquirer input device;
presenting the information associated with the plurality of financing options in a physically perceptible manner associated with the acquirer input device in the order of the desirability of the plurality of financing options;
in response to input of a selection of a selected financing option chosen from the information associated with the plurality of financing options into the one or more user interfaces:
executing a financial instrument between the acquirer and an entity offering the selected financing option; and
providing the product to the acquirer.

13. The method of claim 12, further comprising identifying an undesirable financing option, associated with an entity, wherein the undesirable financing option exceeds one or more predetermined factors, and in response to identifying the undesirable financing option producing, on a device associated with the entity, an alert associated with the undesirable financing option.

14. The method of claim 12, wherein the plurality of financing options are leases, wherein at least one lease of the leases comprises a collateralized portion associated with a first interest rate and uncollateralized portion associated with a second interest rate, different than the first interest rate.

15. The method of claim 12, wherein the product is a vehicle.

16. The method of claim 12, wherein the market transactions comprise historical and real time product valuations comprising:
retail product pricing from multiple years; and
wholesale product pricing from multiple years.

17. A method for facilitating financing of a product by an acquirer, the method comprising;
displaying one or more graphical user interfaces on a display associated with an acquirer input device;
receiving, from at least one input on the acquirer input device, product information;
in response to receipt of the product information, dynamically using weighted historical and real time product valuations to calculate a residual value of the product;
dynamically using the residual value of the product to determine a plurality of financing options;
ranking the plurality of financing options in order of desirability;
sending information associated with the plurality of financing options to the acquirer input device; and
displaying the information associated with the plurality of financing options on the display in the order of the desirability of the plurality of financing options.

18. The method of claim 17, further comprising, in response to an input of a selection of a selected financing option chosen from the information associated with the plurality of financing options:
executing a financial instrument between the acquirer and an entity offering the selected financing option; and
providing the product to the acquirer.

19. The method of claim 17, further comprising receiving, from the at least one input on the acquirer input device, information associated with acquirer.

20. The method of claim 19, wherein the plurality of financing options comprise financing options approved based on at least:
the product information; and
the residual value of the product.
